(19) United States
(12) Patent Application Publication
(10) Pub. No.: US 2010/0221112 A1
(43) Pub. Date: Sep. 2, 2010

(54) SYSTEM AND METHOD FOR AIRBORNE CYCLICALLY CONTROLLED POWER GENERATION USING AUTOROTATION

(76) Inventors: JOEBEN BEVIRT, Santa Cruz, CA (US); Lan Kroo, Stanford, CA (US)

Correspondence Address: MICHAEL A. GUTH, 2-2905 EAST CLIFF DRIVE, SANTA CRUZ, CA, 95062, US

(21) Appl. No.: 12/566,665

(22) Filed: Sep. 25, 2009

Related U.S. Application Data
(60) Provisional application No. 61/194,989, filed on Oct. 1, 2008.
(60) Provisional application No. 61/205,506, filed on Jan. 20, 2009.

(51) Int. Cl. F03D 11/00

(52) U.S. Cl. 416/135

(57) ABSTRACT

An airborne centrifugally stiffened and cyclically controlled system which uses airfoils which rotate around a central hub, similar to the mechanics of an autogyro. The airfoils may achieve speeds significantly above the wind speed feeding the system. The airfoils may be linked to the central hub by flexible radial tethers which stiffen considerably as the speed of the airfoil increases, or may be linked to the central hub by rigid radial links. The central hub may be linked to the ground with an extendible main tether. Power generation turbines may reside on the airfoils and utilize the high apparent wind speed for power generation. The generated power may travel down the radial tethers and across a rotating power conduit to the main tether and to the ground. The system may use autorotation, similar to the mechanics of an autogyro. Power generation turbines may reside on the blades and utilize the high apparent wind speed for power generation with little or no need for gearing between the generator blades and the generator.

### CROSS-REFERENCE TO RELATED APPLICATIONS

This application claims priority to U.S. Provisional Patent Application 61/194,989 to Bevirt et al., filed Oct. 1, 2008, which is hereby incorporated by reference in its entirety. This application claims priority to U.S. Provisional Patent Application 61/205,506 to Bevirt et al., filed Jan. 20, 2009, which is hereby incorporated by reference in its entirety.

### BACKGROUND

1. Field of the Invention

This invention relates to power generation, and more specifically to airborne wind-based power generation.

2. Description of Related Art

Wind turbines for producing power are typically tower mounted and utilize two or three blades cantilevered out from a central shaft which drives a generator, usually requiring step up gearing due to the low rotational speed of the blades. Although some airborne windmills are known in the art, they tend towards suspending an apparatus similar to that which would be tower mounted with a balloon or other lift device. An example of a balloon supported device is seen in U.S. Pat. No. 4,073,516, to Kling, which discloses a tethered wind driven floating power plant.

Another aspect of tethered power generation involves a tether, or load cable, linking an airborne airfoil to a mechanical power generation means on the ground. An example of such a device is seen in U.S. Patent Application Publication No. US2007/0228738, to Wrage et al., disclosing a parachute flying in the air and transmitting mechanical force to the ground.

### SUMMARY

An airborne centrifugally stiffened and cyclically controlled system which uses airfoils which rotate around a central hub, similar to the mechanics of an autogyro. The airfoils may achieve speeds significantly above the wind speed feeding the system. The airfoils may be linked to the central hub by flexible radial tethers which stiffen considerably as the speed of the airfoil increases, or may be linked to the central hub by rigid radial links. The central hub may be linked to the ground with an extendible main tether.

Power generation turbines may reside on the airfoils and utilize the high apparent wind speed for power generation. The generated power may travel down the radial tethers and across a rotating power conduit to the main tether and to the ground.

The airborne assembly may have the rotational speed of the airfoils, its altitude, and its attitude controlled using control surfaces linked to the airfoils. The attitude and altitude sensors and the control system may be airborne and may be part of the rotating assembly. The airborne assembly can be moved to areas of appropriate wind speed for the system using these controls.

An airborne system for power generation using airfoils or blades which are linked to a central rotor hub and rotate using autorotation, similar to the mechanics of an autogyro. Power generation turbines may reside on the blades and utilize the high apparent wind speed for power generation with little or no need for gearing between the generator blades and the generator.

### BRIEF DESCRIPTION OF THE DRAWINGS

FIG. 1 is a sketch of a centrifugally stiffened cyclically controlled system according to some embodiments of the present invention.

FIG. 2 is a sketch of the rotation portion of a centrifugally stiffened cyclically controlled system with two airfoils according to some embodiments of the present invention.

FIG. 3 is a sketch of the rotation portion of a centrifugally stiffened cyclically controlled system with three airfoils according to some embodiments of the present invention.

FIG. 4 is an illustrative sketch of different operation aspects of a centrifugally stiffened cyclically controlled system according to some embodiments of the present invention.

FIG. 5 is a sketch of a centrifugally stiffened cyclically controlled power generation system showing rotational and lift directions according to some embodiments of the present invention.

FIG. 6 is sketch of a centrifugally stiffened cyclically controlled power generation system illustration differential airflows according to some embodiments of the present invention.

FIG. 7 is a sketch of an airfoil with a tail section including a housed power generation turbine according to some embodiments of the present invention.

FIG. 8 is a sketch of an airfoil with a tail section including an unhoused power generation turbine according to some embodiments of the present invention.

FIG. 9 is a sketch of a flying wing including a housed power generation turbine according to some embodiments of the present invention.

FIG. 10 is a sketch of a centrifugally stiffened cyclically controlled power generation system according to some embodiments of the present invention.

FIG. 11 is a sketch illustrating the air velocities over rotating airfoils.

FIG. 12 is a sketch of the rotation portion of a cyclically controlled system with two airfoils rigidly linked according to some embodiments of the present invention.

FIG. 13 is a sketch of a rigid rotation portion of a cyclically controlled power generation system according to some embodiments of the present invention.

FIG. 14 is a sketch of a cyclically controlled system with two airfoils rigidly linked according to some embodiments of the present invention.

FIG. 15 is a sketch of a cyclically controlled power generation system with two airfoils rigidly linked according to some embodiments of the present invention.

FIG. 16 is a sketch of a cyclically controlled power generation system with a rigid rotor according to some embodiments of the present invention.

FIG. 17 is a sketch of a tethered flying system with a plurality of autorotating blades according to some embodiments of the present invention.

FIG. 18 illustrates a docking system base unit according to some embodiments of the present invention.

### DETAILED DESCRIPTION

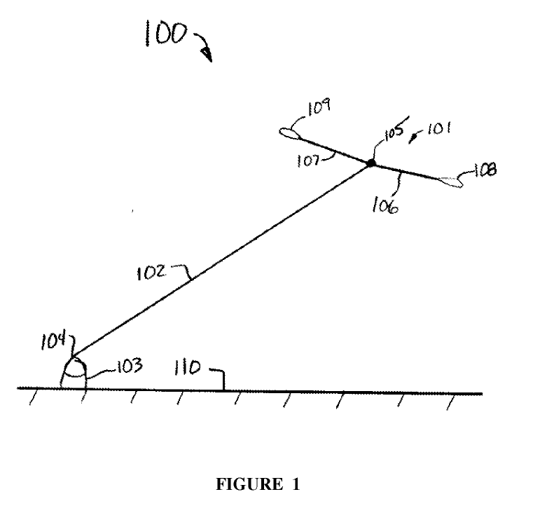

In some embodiments of the present invention, as seen in FIG. 1, a centrifugally stiffened cyclically controlled airborne system 100 has a rotating portion 101 attached by a flexible main tether 102 to a base unit 103. The rotating portion 101 may have a first radial link 106 linking a first lift section 108, which may be a controlled airfoil, to a rotor hub 105. A second radial link 107 links a second lift section 109, which may be a controlled airfoil, to the central hub 105. The central, or rotor, hub 105 is attached to the outboard end of a main tether 102 which is extended from an extension unit 104 on a main base unit 103. The main base unit resides upon the ground 110, although it may reside upon a floating platform or other anchoring system in some embodiments. The radial links 106, 107 may be flexible tethers in some embodiments.

The system is adapted to allow the airfoils engage in autorotation. In a traditional autogyro, the rotating airfoils are propelled through the air with the use of an engine and propeller. The forward motion of the autogyro machine (once the rotating airfoils have been initiated into rotation) furthers autorotation of the rotating airfoils, which in turn provide lift for the autogyro machine. Flying autogyro machines sometimes appear to the eye to be a combination airplane and helicopter, but typically the rotating airfoils are not powered.

In some embodiments of the present invention, the rotating airfoils provide lift similar to the rotating airfoils of an autogyro machine, but are tethered in position in a prevailing wind, and it is this wind that encourages and continues the autorotation of the rotating airfoils.

In some embodiments, the main tether 102 is adapted to be let out from an extension unit 104 which may include a rotating drum unit adapted to rotate to extend or withdraw the tether. In some embodiments, the bulk of the length of the unextended portion of the tether may be stored separately from the rotating drum unit, allowing the drum unit to be smaller in size and allowing the radius of rotation of the drum unit and tether at the point where the tether is being extended to be the same radius at all times. In some embodiments, the main tether 102 is flexible and adapted to be wound around a drum.

The rotating assembly 101 is adapted to rotate in a plane at an angle to the main tether 102. In some embodiments, the rotating assembly 101 is allowed to rotate circularly around the main tether 102 without twisting the tether due to a rotational coupling at the central hub 105. The rotational coupling may utilize mechanical bearings, magnetic bearings, or other means.

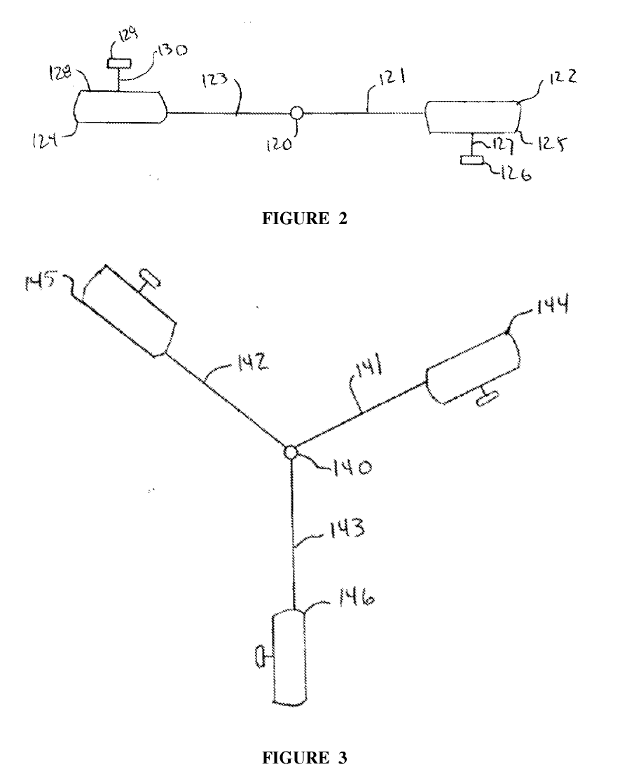

In some embodiments, as seen in FIG. 2, the rotating assembly consists of two lift sections, which are controllable airfoils. A first airfoil 125 is attached to the central, or rotor, hub 120 by a first radial link 121. The first airfoil 125 may consist of a wing 122, a tail structure 127, and a tail 126. In some embodiments, the tail 126 includes a controllable elevator which allows for control of the angle of attack of the wing 122. A second airfoil 124 is attached to the rotor hub 120 by a second radial link 123. The second airfoil may consist of a wing 128, a tail structure 130, and a tail 129. The tail may include a controllable elevator which allows for control of the angle of attack of the wing 128. In some embodiments, the airfoils may have other controllable surfaces, including rudder function, ailerons, and flaps.

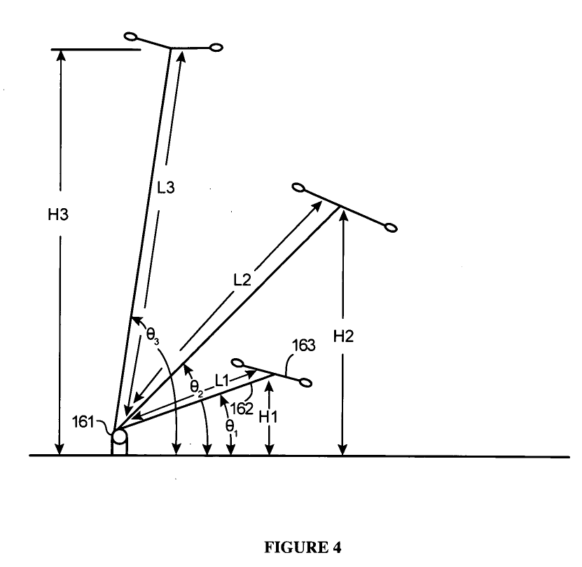

In some embodiments of the present invention, as seen in FIG. 3, the rotation assembly consists of three controllable airfoils. A first airfoil 144 is attached to the rotor hub 140 by a first radial link 141. A second airfoil 145 is attached to the rotor hub 140 by a second radial link 142. A third airfoil 146 is attached to the rotor hub 140 by a third radial link 143. Other numbers of airfoils may be used in other embodiments.

In some embodiments, the radial links are flexible tethers. The rotating assembly is adapted such that the airfoils generate forward motion relative to the airfoil wing, and are constrained laterally by the radial tethers. This constraint results in a predominantly circular flight path by the airfoil around the rotor hub. As the speed of the airfoils increases, the centrifugal forces result in higher loads in the radial links. As the tension increases in the radial tethers, the effective stiffness of the system increases. As the airfoils engage in their circular flight, they are able to achieve rotational speeds which result in air speed over the wing of the airfoil that is significantly higher than the exterior, ambient wind speed. The controllable aspect of the airfoil, for example the elevator control, allows the angle of attack of the wing of the airfoil to be adjusted, which gives control over the rotational velocity of the airfoils and of the entire rotating assembly, of which the airfoils are a part.

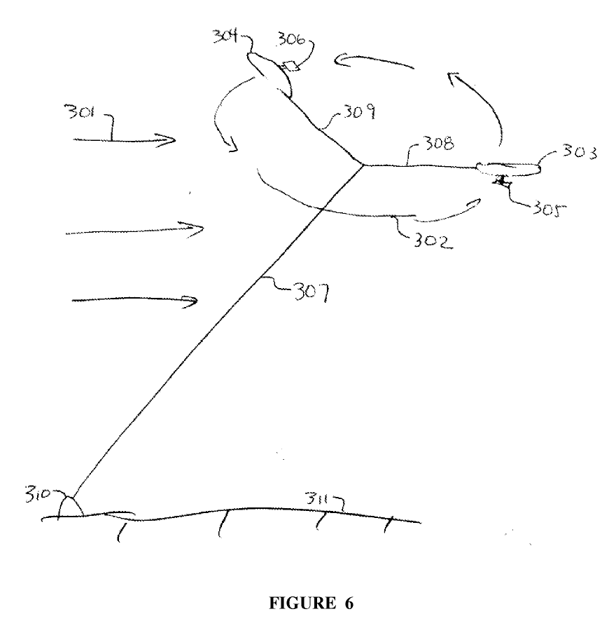

FIGS. 4 and 6 illustrate some aspects of the cyclically controlled system according to some embodiments of the present invention. As seen in FIG. 4, a main tether 162 anchored to a base unit 161, and its rotating assembly 163, may be used in a variety of altitudinal and attitudinal scenarios. The system may be flown at different altitudes for different reasons. In some cases, a boundary layer may prevent prevailing wind of sufficient strength or consistency from occurring near the ground. In such a case, the system may need to be flown above the boundary layer. In another case, the system may seek to fly in much higher altitude winds, such as seen with a jet stream. In other cases, the system may need to be raised or lowered to avoid winds which are too high or too low, or to avoid weather features, or for other reasons. In some embodiments, the system may include interactivity with a wind monitoring system which is adapted to look upwind and determine coming windspeeds. The wind monitoring system may be able to sense windspeed many miles into the upwind direction, and differentiate windspeed based upon altitude as well. The cyclically controlled system may be raised and lowered in altitude based upon the input from this wind monitoring system.

In a first scenario, the main tether has been reeled out for a total length L1 at an angle relative to the ground of θ1, resulting in a height H1 of the rotator hub. It is understood that with a flexible tether that the main tether is not truly linear, and θ1 may be understood to be the angle between the base unit and the rotor hub. This low angle of incidence may be seen shortly after takeoff of the airfoils, or may be lower than actually seen in normal flight scenarios, and is used in illustrative example.

In a second scenario, the main tether has been reeled out for a total length L2 at an angle relative to the ground of θ2, resulting in a height H2 of the rotator hub. This may be exemplary of scenario wherein a system flies above a near ground boundary layer.

In a second scenario, the main tether has been reeled out for a total length L2 at an angle relative to the ground of θ2, resulting in a height H2 of the rotator hub. This may be exemplary of scenario wherein the system has been raised up into the jet stream.

In some embodiments, the system may be moved from one altitude to another, or one angle of incidence of the main tether θ to another, using a control system controlling the airfoils on the outboard ends of the radial tethers.

FIG. 6 illustrates a system flying in an ambient wind velocity V1 at the altitude of the rotating assembly. The rotating assembly is seen flying with a rotational velocity ω1. The individual airfoils 303, 304 are attached to a rotating hub with tethers 308, 309 of a length r1. The velocity of the airfoils is r1*ω1. The apparent windspeed over the airfoils will differ depending upon which portion of the circular flight path 302 they are in. For example, a first airfoil 304 heading into the ambient wind will have the ambient wind speed added to the velocity due to rotation to arrive at the windspeed over the airfoil. A second airfoil 303 heading away from the ambient wind direction will have the ambient wind speed subtracted from the velocity due to rotation to arrive at the windspeed over the airfoil.

The differences in the simultaneous windspeeds over the two airfoils will result in different lift and drag from the two airfoils. Thus, without control of the airfoils to counteract this aspect, one portion of the circular flight path 302 will have increased lift and another will have decreased lift. This will take the rotating assembly's plane of rotation off of perpendicular from the main tether, taking the lift vector off of parallel with the main tether and will tend to move the main tether. Thus, control of the angle of attack of the airfoils as they pursue their flight path may be required to maintain a steady position of the circular flight path, and such control may also be required to perform planned movements of the tether and airfoils.

Planned movement of the main tether 307, or retention of the main tether in the same position in light of the differential lift aspect mentioned above, may be addressed using a control system which takes into account the cyclical nature of the forces on each airfoil. The first airfoil 303 may have an elevator control surface 305, and the second airfoil 304 may have an elevator control surface 306. Cyclical manipulation of these control surfaces as the airfoils go through a cycle of rotation may be used to do planned movement, or purposeful stabilization, of the main tether, and with it the position of the rotating assembly. For example, in the case of purposeful stabilization and position retention of the main tether and rotation assembly, the elevator control surface of an airfoil can be adjusted in a first direction as the airfoil is coming around the rotation cycle into the ambient wind. The elevator control surface of this airfoil can then be adjusted in a second direction as the airfoil comes around the rotation cycle away from the ambient wind. With such a cyclically controlled system, planned movement or purposeful retention of position can be accomplished. In some embodiments, such as embodiments using rigid radial links, the airfoils may have their angles of attack changed using mechanical control. For example, the airfoil may be rotationally constrained relative to the rigid radial link to which it is attached, and the rigid radial link may be positionally controlled in rotation using a controlled mechanism. Also, the rigid radial links may be rotationally constrained relative to the central hub, and the airfoil may be positionally controlled in rotation relative to the rigid radial link.

In some embodiments, the flying system may be used to generate pull along the tether from the rotating portion to the ground unit. The pull may be used to power a generator or other device. The force in tether may be used to pull on a drum which in turn rotates a shaft, providing mechanical input for an electrical generator. The ground unit may then reel back in the tether while the rotating portion has been controlled to generate less force on the tether. The sequence may then be continually repeated. The pull of the rotating portion may be controlled by controlling the composite lift generated by all of the rotating lift portions.

FIG. 11 illustrates the differential wind speed seen in a fixed rotor rotating in an oncoming wind. As seen, there is differential wind speed on a rotor blade or airfoil as it rotates through a cycle. This in turn results in differential lift and drag.

In some embodiments of the present invention, the central, or rotor, hub itself may have aerodynamic or airfoil aspects in its design. In some embodiments, the rotor hub may have control surfaces that enable it to direct motion of the rotor hub in a prevailing wind. In some embodiments, there may be aerodynamic aspects to the rotor hub adapted to stabilize the rotor hub, whether against buffeting from the prevailing winds, differential pulling from the radial tethers, or for other reasons.

In some embodiments of the present invention, the rotor hub may have a variety of sensors adapted to be used by a control system controlling the rotating assembly. Altitude sensors, attitude sensors, and wind speed sensors may be mounted on or near the rotor hub. In some embodiments, the air speed over the airfoils may be registered by sensors on the airfoils. Other position, attitude, altitude, and air speed sensors may be mounted in various locations along the system to assist in control of the system.

In some embodiments, most or all of the sensors used in a control system to cyclically control and stabilize the rotating assembly may be mounted on the rotating assembly, and on the non-rotating portion of the rotor hub. In some embodiments, the control system electronics may also be mounted on the rotating assembly, and on the non-rotating portion of the rotor hub.

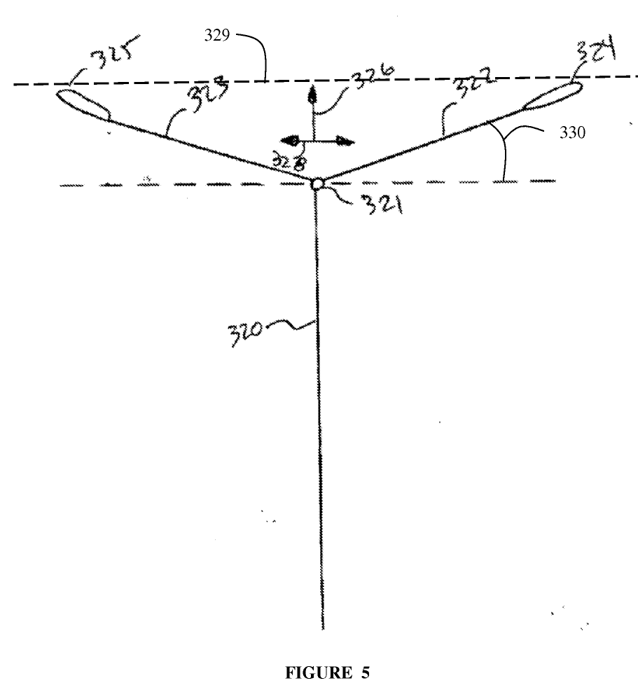

FIG. 5 illustrates aspects of a cyclically controlled centrifugally stiffened system according to some embodiments of the present invention. A main tether 320 is linked to a rotating portion with two airfoils 324, 325. The two airfoils 324, 325 are linked to a rotor hub 321 by flexible radial tethers 322, 323. As the airfoils fly in a wind coming from under the rotating assembly at an angle along the main tether 320, which is dragged downwind from the main base by the ambient wind, the lift of the airfoils tends to raise the airfoils in a direction 326 somewhat parallel to the main tether 320. As the airfoils are constrained by the radial tethers, this lift will not raise the airfoil straight along the lift direction, but the airfoils will be moved by forces in this lift direction in an arc swept out with a radius of the length of the radial tether. The tip path plane 329 is seen as the plane within which the airfoils sweep as they rotate. The coning angle 330 is seen as the angle above a hypothetical “flat” plane which would be circumscribed without lift of the airfoils, and which may not be parallel to the ground. The angle between the tip plane path and the ground may be referred to as the angle of incidence “i”.

Rather than being swept up along the lift direction and ending up in a position along a line extended from the main tether, a counterbalancing set of forces comes into play. As the airfoils 324, 325 speed up in their circular and cyclical flight paths, there are centrifugal forces 328 which put forces on the airfoils to move them radially away from the rotor hub. The radially outward forces then also tend to flatten the flight path of the airfoils, reducing the coning angle. Thus, no radial links of stiff material, and no resistance of bending moment at the rotor hub, are needed to keep the airfoils “flattened” in their circular flight paths. The speed of the airfoils can be manipulated to increase the speed and to “flatten” the flight profile.

In some embodiments of the present invention, a control system is adapted to control one or more aspects of the centrifugally stiffened cyclically controlled system. A processor may reside on the ground in some aspects, and utilize inputs from airspeed sensors on the airfoils, ambient wind speed sensors on the rotor hub, ambient wind speed sensors remotely located or adapted to read wind speed at a distance, attitude and altitude sensors, and other sensors to determine the values of these parameters related to control of the rotating portion's location, altitude, rotational velocity, and other aspects. The control system may then receive input from an operator, or run pre-determined operational paradigms, and utilize control surfaces on the rotating portion, and extend or retract the main tether, in order to control the system.

In the case of cyclical control, the control system may take into account processing delays, electrical delays, and airfoil control system delays in order to phase shift the commands to control surfaces such that actions occur at the desired time.

Because the airfoils can be controlled to obtain very high rotational velocities, the apparent airspeed over the wings can become very high. This circumstance presents an opportunity to harvest energy from the very high localized airspeeds obtained as the airfoils obtain these high rotational velocities, even in ambient wind speeds that are much lower. Wind turbine driven electrical power generators or other types of wind driven power generators, may be integrated into, onto, or near the airfoils to take advantage of the high airspeeds generated by the circular flight paths. In the case of wind turbine driven electrical power generators, electrical power generated at the airfoils may be transferred via conductors along the radial tethers, through a rotating power conduit at the rotor hub, and then transferred to the ground via conductors along the main tether.

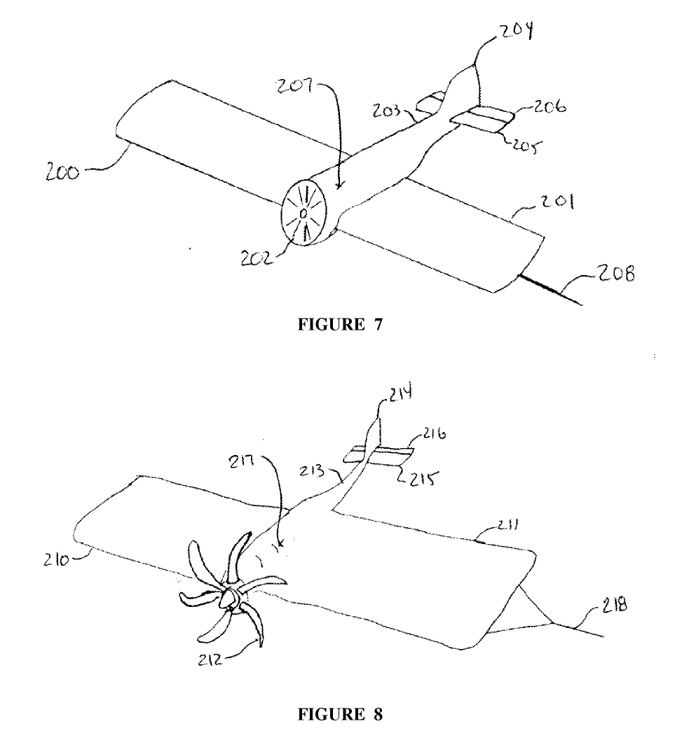

FIGS. 7, 8, and 9 illustrate airfoils with turbine driven electrical generators according to some embodiments of the present invention. In some embodiments of the present invention, as seen in FIG. 7, an airfoil 200 adapted to be flown on the end of a radial tether 208 has a housed turbine driven electrical generator 207 within the airfoil. The wing 201 of the airfoil 200 is radially constrained during its rotational flight path by a radial tether 208. The radial tether 208 may perform a dual function of being a structural attachment to the rotor hub, as well as an electrical power conduit for the electrical power developed by the power generation turbine. The airfoil 200 may have a tail structure 203 with a vertical stabilizer 203 and a horizontal stabilizer 205. The horizontal stabilizer 205 may have a controllable elevator 206, or other type of elevator control. Although the airfoils are shown with a controllable elevator, in the case of stiff radial links the airfoil angle of attack may be controlled with the use of mechanisms at the rotor hub interface, or at the airfoil/radial link interface.

The rotor blades 202 of the housed turbine driven electrical generator 207 are housed within the structure of the airfoil or an adjoining cowling. Utilizing the high speed airflow available due to the high rotational velocity of the rotating portion of the system, the turbine is able to develop its own high rotation speed and drive an electrical generator. Due to the high speeds attained by the airfoil in its cyclical flight path and the high rotational speeds in the turbine blades 202, the power generator may be able to forego the use of gearing that may otherwise be required with systems operating in lower wind speeds.

In some embodiments of the present invention, as seen in FIG. 8, an airfoil 210 adapted to be flown on the end of a radial tether 218 has a turbine driven electrical generator 217 within the airfoil powered by a propeller 212. The wing 211 of the airfoil 210 is radially constrained during its rotational flight path by a radial tether 218. The radial tether 218 may perform a dual function of being a structural attachment to the rotor hub, as well as an electrical power conduit for the electrical power developed by the turbine driven electrical generator. The airfoil 210 may have a tail structure 213 with a vertical stabilizer 214 and a horizontal stabilizer 215. The horizontal stabilizer 215 may have a controllable elevator 216, or other type of elevator control.

The turbine blades/propeller 212 of the generator 217 is forward of the structure of the airfoil. Utilizing the high speed airflow available due to the high rotational velocity of the rotating portion of the system, the turbine is able to develop its own high rotation speed and drive an electrical generator. Due to the high speeds attained by the airfoil in its cyclical flight path and the high rotational speeds of the turbine blades/propeller, the turbine driven electrical generator may be able to forego the use of gearing that may otherwise be required with systems operating in lower wind speeds.

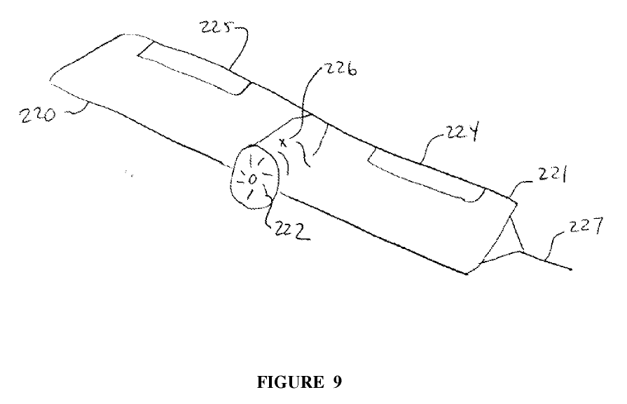

In some embodiments of the present invention, as seen in FIG. 9, a flying wing type airfoil 220 adapted to be flown on the end of a radial tether 227 has an electrical generator 226 within the airfoil powered by housed turbine blades 222. The wing 221 of the airfoil 220 is radially constrained during its rotational flight path by a radial tether 227. The radial tether 227 may perform a dual function of being a structural attachment to the rotor hub, as well as an electrical power conduit for the electrical power developed by the power generation turbine. The airfoil 220 may have ailerons 224, 225 for elevation control to control the angle of attack of the airfoil.

In some embodiments, system may be designed to generate 10 MW. The sweep of the rotating portion may have a diameter of 150-200 meters. The system may be used with a large range of sizes, from smaller systems designed to operate at 0-200 meters altitude, to larger systems designed to operate at altitudes of 50,000 feet or more. Systems which large rotating portions may be used at low altitudes as well as high altitudes. Systems with small rotating portions may be used at low altitudes as well as high altitudes.

In some embodiments of the present invention, drag from the airfoil mounted turbine driven electrical generators may be used as part of the control system of the overall system. For example, drag may be modified by reducing or increasing the electrical load on the generators on the airfoils. Reduced drag may be used during periods where increased speed of the airfoils is desired, and increased drag may be selected for reasons of stability of the system, or for other reasons.

In some embodiments of the present invention, the airfoils with electrical power generation capability may also have the capability of electrically powered flight. For example, instead of using the generator and its turbine as a power generation source, the system is instead used to power the flight of the airfoil. In this type of scenario, electrical power may be supplied via the base unit, travel along the electrical conduit of the main tether, be transferred at the rotor hub with a rotating power coupling to the radial tethers, and be used to drive the generator as a motor. The blades/propeller of the airfoils are then used for propulsion of the airfoil. The powered flight option may be used to maintain the airborne status of the rotating assembly in wind conditions that are not sufficient or suitable for flight of the airfoils. Also, the powered flight option may be used to initiate the flight sequence of the system. The powered flight option may be used to get the airfoils airborne, including the use of vertical take-off scenarios.

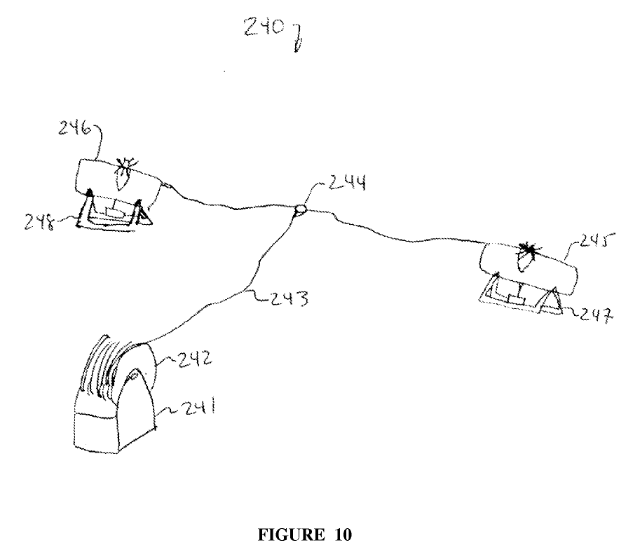

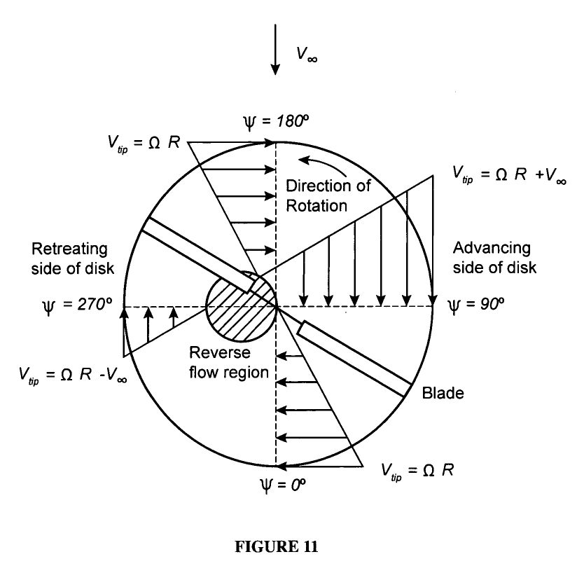

FIG. 10 is a sketch illustrating a takeoff scenario of a system 240 according to some embodiments of the present invention. A base unit 241 has a main tether retraction/extension portion 242 adapted to extend and retract the main tether 243. A rotor hub 244 resides at the outboard end of the main tether and provides a link to the two rotating airfoils 245, 246. The airfoils are seen mounted in stands 247, 248 adapted to facilitate vertical take-off. The airfoils are adapted to lift themselves using electrical power from the base unit that has traveled along the main tether, through the rotor hub, and along the radial tethers. Although a vertical take-off scenario is illustrated, other take-off scenarios may be used. For example, the airfoils may reside in launch ramps adapted to propel the airfoils into flight, or may take off along the ground like traditional aircraft, although in a radial fashion. In some embodiments wherein there are not motors on the airfoils, the airfoils may be started in their rotation using a circular launch system, such as a circular catapult, which is adapted to start the airfoils in their flight paths until the aerodynamics of autorotation begin.

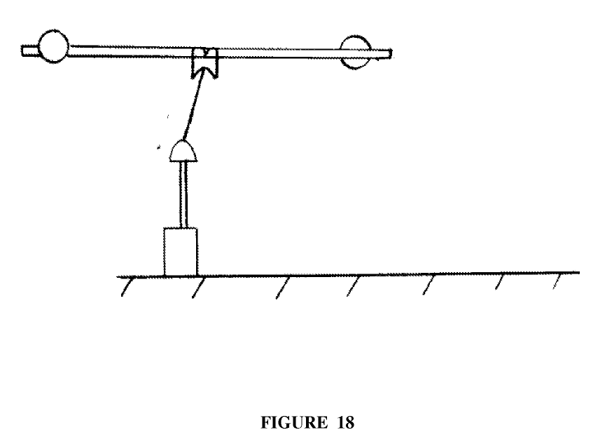

Other takeoff scenarios for the airfoils may be used in some embodiments, including using balloons to assist in the initial lifting of the airfoils. In the case of stiff radial links, the rotor hub may be raised above the ground, suspending the airfoils, such as with the use of a tower, and the rotation can begin and then lift the entire rotating portion upward. An example of a tower base unit is seen in FIG. 18.

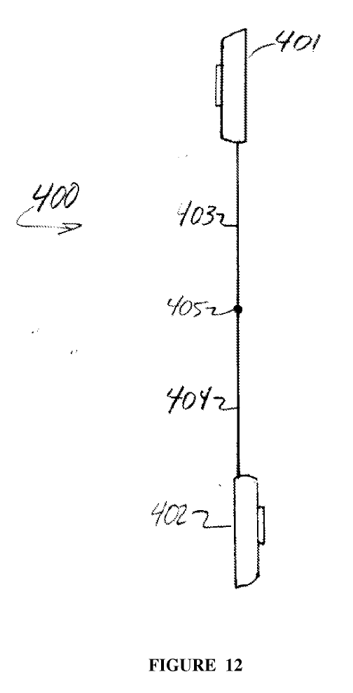

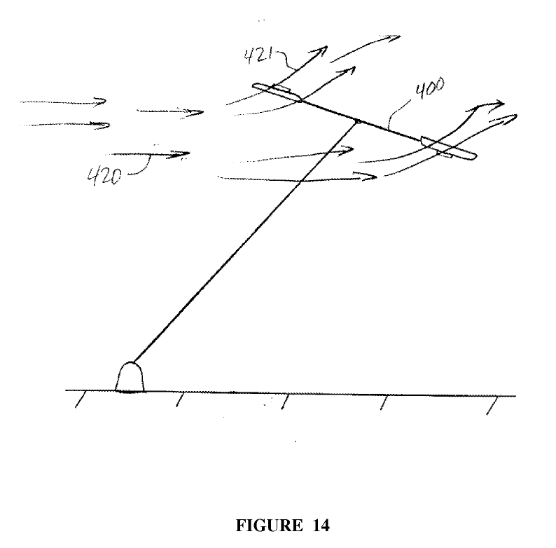

In some embodiments of the present invention, as seen in FIGS. 12-16, the rotating assembly may be substantially rigid, in contrast to the rotating assemblies described above with flexible tethers. In an extended airfoil system embodiment 400 as seen in FIG. 12, airfoils 401, 402 are linked to rotor hub 405 with rigid radial links 403, 404. As seen in FIG. 14, when in flight the system 400 utilizes the oncoming wind 420, which is deflected upwards 421 through the airfoils. With the rigid radial links, the system 400 appears to operate as an autogyro tethered to the ground. For the purposes of this application, a radial link is deemed to be substantially flexible when using cables or flexible tethers, which are not adapted to support the airfoil in a cantilevered fashion. A radial link is deemed to be substantially rigid when the link is adapted to support the link and the airfoil in a cantilevered fashion, as when the main hub is supported or captured. Although a substantially rigid link may of course have deformation, it nonetheless is adapted to support the link and airfoil.

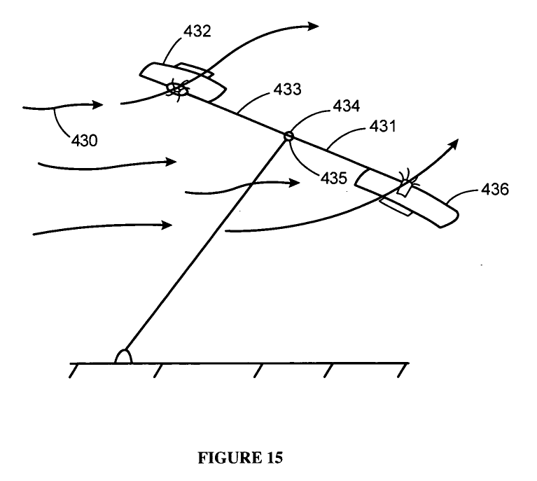

In some embodiments of the present invention, as seen in FIG. 15, an extended airfoil system 431 may be adapted for power generation. The airfoils 432, 436 may include turbine driven electrical generators within them which are adapted to generate electrical power. The turbine driven electrical generators may take advantage of the high airflow speeds over the airfoils resulting from the high rotational speeds of the airfoils due to autorotation. The oncoming winds 430 are routed up through the rotational plane of the rotating airfoils. The airfoils 432, 436 may be linked to the rotor hub 434 with rigid radial links 431, 433.

In some embodiments of the present invention, there may be more than one generator associated with each lift section or airfoil. For example, each airfoil may have two turbine driven generators which may be spaced radially outward from the central hub on or near the airfoil.

In one example of a controlled flying system, the rotating portion of the system consists of two wings with a rotation diameter of approximately 22 feet. Each airfoil is a wing with a span of 90 inches, with an 8 inch chord. The wings have a foam core with a CFC/GFC skin. The wings are rigidly attached to radial links, which are spars of 42 inch length approximately 2.5 inches back from the leading edge of the wings. The spars are CFC tubes with an outside diameter of 0.825 inches, and a wall thickness of 0.080 inches.

The spars connect to a rotor hub assembly approximately 4 inches by 14 inches by 3.5 inches in size, weighing about 7 pounds. Each spar is connected to the rotor hub using two ball bearing assemblies spaced approximately 4 inches apart. The rotor hub attaches to the tether with a gimbal and ball bearings, with power transfer across the rotor hub via a slip ring.

The wings are controlled using full flying elevators at the end of a 2 foot tail boom on the fuselage, mounted at the outer airfoil tips. Brushless electric motors are mounted on the front of the fuselages, using 15×10 inch propellers. The motors have 250 kV windings, approximately 2 KW capacity each. The power for the motors in powered flight comes from the ground and via the tether at 50V.

In another example of a controlled flying system, the rotating portion of the system consists of two wings with a rotation diameter of approximately 37 feet 8 inches. Each airfoil is a wing with a span of 90 inches, with an 8 inch chord. The wings have a foam core with a carbon fiber composite/glass fiber composite (CFC/GFC) skin. The wings are rigidly attached to spars of 136 inch length approximately 2.5 inches back from the leading edge of the wings. The spars are CFC tubes with an outside diameter of 0.945 inches, and a wall thickness of 0.748 inches.

The spars connect to a rotor hub assembly approximately 6 inches by 28 inches by 3 inches in size, weighing about 8 pounds. Each spar is connected to the rotor hub using two ball bearing assemblies spaced approximately 10 inches apart. The rotor hub attaches to the tether with a three axis gimbal, with power transfer across the rotor hub via a slip ring.

The wings are controlled using full flying elevators at the end of a 2 foot tail boom on the fuselage, mounted at the outer airfoil tips. Brushless electric motors are mounted on the front of the fuselages, using 15×10 inch propellers. The motors have 250 kV windings, approximately 2 KW capacity each. The power for the motors in powered flight comes from the ground and via the tether at 50V.

In both of the examples described above, each airfoil has a full flying elevator controlled by hobby servos. Each airfoil has an altitude and heading reference system (AHRS) sensor package mounted at or near the root of each spar, providing filtered three dimensional attitude and heading information. In some embodiments, the sensor package has three 1200 deg/sec MEMS gyros, three +/−5 g accelerometers, three axis magnetometer, and temperature compensation. The attitude and heading information may be filtered using a Kalman filter. The control system includes an ARM7 control board reading attitude information and driving elevator servo commands. Ground control includes a 900 MHz 2 way RF modem link to a ground station.

In some embodiments of the present invention, the turbine driven generators may be mounted outboard of the lift sections, or airfoils. For example, in case wherein the airfoil is linked to the central hub with a rigid radial link, the turbine driven generator may be mounted radially outboard from the airfoil.

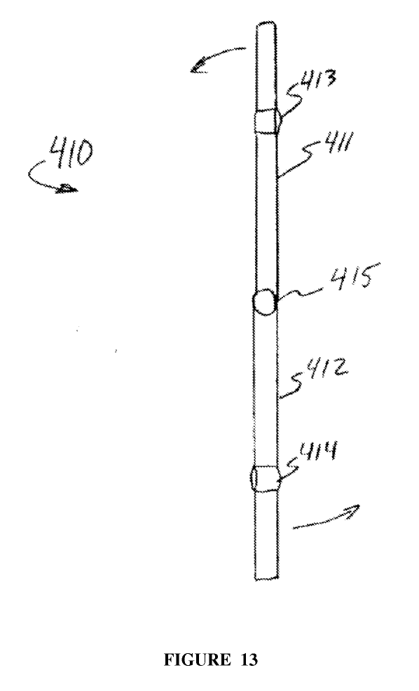

In some embodiments of the present invention, a rotating blade system 410 may be adapted to autorotate and generate electrical energy. In some embodiments of the present invention, as seen in FIG. 13, a rotation portion 410 of a tethered system has a first blade 412 and a second blade 411 coupled to a rotor hub 415. The blades 411, 412 may have turbine driven electrical generators 413, 414 adapted to translate wind energy in to electrical power. The turbine driven electrical generators may be smaller and lighter than typical wind power generator systems due to the high windspeeds generated over the airfoils during autorotation, which may preclude the need for heavy and bulky gear systems between the impeller of the turbine and the generator.

In some embodiments, the blades 411, 412 may be linked to the rotor hub 415 using joints which allow for some motion of the blades relative to the rotor hub. The joints may include spring loaded or otherwise damped radial joints to allow for some motion of the blades along their rotation path relative to the rotor hub. The joints may include spring loaded or otherwise damped joints which allow for some motion of the blades perpendicular to the rotation axis of the blades. In some embodiments, the angle of attack of the blades relative to the rotor hub may be controlled my mechanisms at the junction of the blade with the rotor hub.

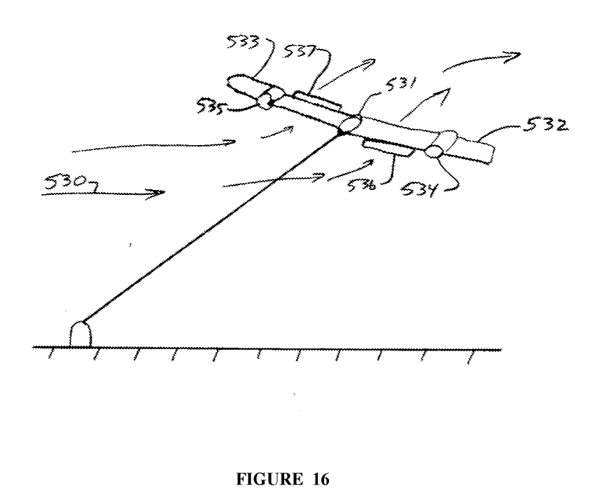

In some embodiments of the present invention, as seen in FIG. 16, a tethered power generation system utilizes an autorotating set of blades with integral turbine driven electrical generators. The blades 532, 533 with their turbine driven electrical generators 534, 535 rotate around a rotor hub 531. The blades may have control surfaces 536, 537 adapted to provide control of the blades to assist in stabilization of the rotating portion, or to raise or lower the rotating portion to different altitudes.

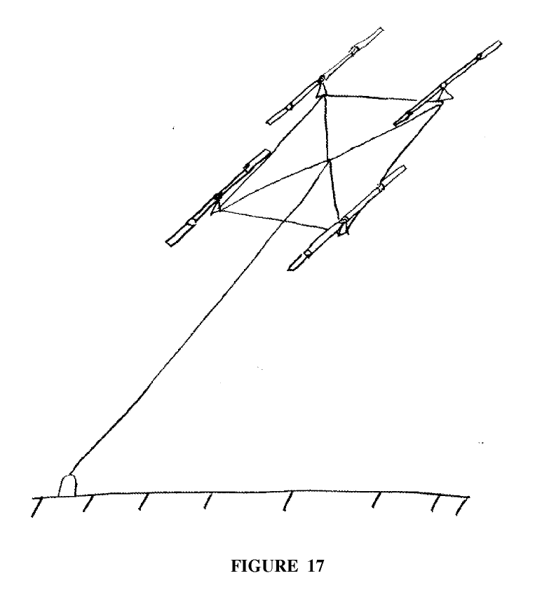

In some embodiments of the present invention, as seen in FIG. 17, a plurality of autorotating blades may be flown with a supporting intermediate structure tethered to the ground.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A wind driven system, said system comprising:
a substantially flexible main tether;
a base unit, said base unit coupled to a first end of said main tether;
a central hub, said central hub comprising a first portion and a second portion, said second portion adapted to rotate relative to said first portion, said first portion coupled to a second end of said main tether;
a plurality of lift sections; and
a plurality of radial links, each of said plurality of radial links coupled to the second portion of said central hub at a first end and coupled to one of said plurality of lift sections at a second end.

2. The wind driven system of claim 1 wherein said lift sections are coupled to said radial links at a first end, and wherein said left sections are adapted to provide lift while rotating around said central hub.

3. The wind driven system of claim 2 wherein said radial links are substantially flexible radial links.

4. The wind driven system of claim 2 wherein said radial links are substantially rigid radial links.

5. The wind driven system of claim 3 wherein each of said plurality of lift sections comprises a control surface adapted for elevation control of the lift section.

6. The wind driven system of claim 4 wherein each of said plurality of lift section comprises a control surface adapted for elevation control of the lift section.

7. The wind driven system of claim 5 wherein said base unit is adapted to extend and retract said main tether.

8. The wind driven system of claim 6 wherein said base unit is adapted to extend and retract said main tether.

9. The wind driven system of claim 2 wherein said radial links are equally spaced around the second portion of said central hub.

10. The wind driven system of claim 7 wherein said radial links are equally spaced around the second portion of said central hub.

11. The wind driven system of claim 7 further comprising a processor, said processor including instructions for controlling said wind driven system.

12. The wind driven system of claim 7 further comprising a control system for said wind driven system.

13. The wind driven system of claim 12 wherein said control system resides at least in part on said central hub.

14. A wind driven power generation system, said system comprising:
a substantially flexible main tether;
a base unit, said base unit coupled to a first end of said main tether;
a central hub, said central hub comprising a first portion and a second portion, said second portion adapted to rotate relative to said first portion, said first portion coupled to a second end of said main tether;
a plurality of lift sections;
a plurality of turbine driven electrical generators, each of said generators coupled to one of said lift sections; and
a plurality of radial links, each of said plurality of radial links coupled to the second portion of said central hub at a first end and coupled to one of said plurality of lift sections at a second end.

15. The wind driven power generation system of claim 14 wherein said lift sections are coupled to said radial links at a first end, and wherein said lift sections are adapted to provide lift while rotating around said central hub.

16. The wind driven power generation system of claim 15 wherein said radial links are substantially flexible radial links.

17. The wind driven power generation system of claim 15 wherein said radial links are substantially rigid radial links.

18. The wind driven power generation system of claim 15 wherein said lift sections are adapted to engage in substantially circular flight around said central hub, and wherein turbine driven generators are adapted to utilize the airspeed generated by the rotational velocity of said lift section to drive their turbines.

19. The wind driven power generation system of claim 17 wherein said lift sections are adapted to engage in substantially circular flight around said central hub, and wherein turbine driven generators are adapted to utilize the airspeed generated by the rotational velocity of said lift sections to drive their turbines.

20. The wind driven power generation system of claim 19 wherein said main tether comprises an electrical conductor, and wherein part or all of the electrical power developed by said turbine driven generators is routed via the conductors in or around the main tether to the ground.

21. The wind driven power generation system of claim 20 wherein said electrical generators are adapted to act as electric motors.

22. The wind driven power generation system of claim 21 wherein said electrical generators are electrically connected to an electrical power source on the ground.

23. The wind driven power generation system of claim 21 wherein said turbine driven generators are adapted to act as motor driven propellers when powered from an external source.

24. A wind driven power generation system, said system comprising:
a flexible main tether;
a base unit, said base unit coupled to a first end of said main tether;
a central hub, said central hub comprising a first portion and a second portion, said second portion adapted to rotate relative to said first portion, said first portion coupled to a second end of said main tether; and
a plurality of blades, said blades attached to said central hub at a first end, said blades adapted to rotate around said central hub.

25. The wind driven power generation system of claim 24 wherein each of said plurality of blades comprises a wind driven electrical generator.

26. The wind driven power generation system of claim 25 wherein said blades are adapted to provide lift while rotating around said central hub.

27. The wind driven power generation system of claim 26 wherein said blades are adapted to engage in substantially circular flight around said central hub, and wherein turbine driven generators are adapted to utilize the airspeed generated by the rotational velocity of said blades to drive their turbines.

28. The wind driven power generation system of claim 27 wherein said tether comprises an electrical conductor, and wherein part or all of the electrical power developed by said turbine driven generators is routed via the conductors in or around the tether to the ground.

29. The wind driven power generation system of claim 28 wherein said electrical generators are adapted to act as electric motors.

30. The wind driven power generation system of claim 29 wherein said electrical generators are electrically connected to an electrical power source on the ground.

31. The wind driven power generation system of claim 30 wherein said turbine driven generators are adapted to act as motor driven propellers when powered from an external source.

32. A method for developing electrical energy using a tethered autorotating flying system, said method comprising:
autorotating a plurality of lift sections around a central hub, said lift sections comprising a turbine driven generator;
generating electrical energy from said turbine driven generators, wherein said turbine driven generators generate electrical energy at least in part utilizing the apparent wind speed developed by the rotational velocity of their autorotation.

33. The method of claim 32 further comprising extending a flexible tether, said flexible tether attached to a ground unit on a first end and said central hub on a second end, wherein the extension of the tether allows for an altitude gain of the central hub.

34. The method of claim 33 further comprising routing all of part of the electrical energy generated by said turbine driven generators to a ground unit.

35. The method of claim 34 wherein routing the electrical energy to the ground unit comprises routing the electrical energy using conductors in or around the tether.

36. The method of claim 35 further comprising beginning the autorotation of the airfoils using the turbine driven generators as thrust producing engines.

37. The method of claim 36 wherein electrical energy is routed to the thrust producing engines from the ground.
